(19) United States
(12) Patent Application Publication
(10) Pub. No.: US 2009/0154508 A1
(43) Pub. Date: Jun. 18, 2009

(54) LIGHT-GENERATING APPARATUS WITH BROADBAND PUMPING LASER AND QUASI-PHASE MATCHING WAVEGUIDE

(75) Inventors: MING HSIEN CHOU, HSINCHU (TW); SHANG LING LIU, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: HC PHOTONICS CORP., HSINCHU (TW)

(21) Appl. No.: 12/026,528

(22) Filed: Feb. 5, 2008

Related U.S. Application Data
(60) Provisional application No. 61/013,050, filed on Dec. 12, 2007.

(51) Int. Cl. H01S 3/109

(52) U.S. Cl. 372/22

(57) ABSTRACT

A light-generating apparatus comprises a broadband pumping laser configured to emit a broadband pumping light having a bandwidth larger than 10 nanometers and a broadband wavelength-converting device. The broadband wavelength-converting device includes a domain-inverted structure configured to convert the broadband pumping light into at least one conversion light by using at least a sum frequency generation mechanism and at least one waveguide positioned in the domain-inverted structure, and the waveguide has an input end configured to receive the broadband pumping light and an output end configured to output the conversion light. Since the light-generating apparatus uses the broadband pumping laser and the broadband wavelength-converting device, it is temperature-insensitive and speckle-free.

The present application is a regular application of U.S. Provisional Patent Application Ser. No. 61/013,050 filed on Dec. 12, 2007; the complete disclosure of which are hereby incorporated herein by reference for all purposes.

### BACKGROUND OF THE INVENTION

(A) Field of the Invention The present invention relates to a light-generating apparatus with a broadband pumping laser and a quasi-phase matching (QPM) waveguide, and more particularly, to a light-generating apparatus with a broadband pumping laser and a broadband wavelength-converting waveguide for converting a pumping light into a broadband conversion light by using the sum frequency generation and the second harmonic generation mechanisms.

(B) Description of the Related Art

Quasi-phase matching (QPM) is a technique for phase matching nonlinear optical interactions in which the relative phase is corrected at regular intervals using a structural periodicity built into the nonlinear medium, and the most popular case of interest in modern QPM technology is called frequency doubling or second harmonic generation (SHG).

Obtaining a meaningful power transfer between an coherent pumping wave and its frequency doubled second harmonic generation allows the production, for example, of coherent green or blue light by the passage of near infra-red radiation from a solid state laser through a non-linear ferroelectric crystal. Since coherent pumping radiation is easier to produce by laser action than coherent radiation, quasi-phase matching devices with second harmonic generation (QPM-SHG) ability have been widely used for high-efficiency wavelength conversion to generate visible lasers.

The most important design aspect of QPM-SHG devices including a ferroelectric single-crystal is the ability to produce periodic polarization-inversion domains with accuracy. Much inventive effort has been expended in finding ways of preparing the periodically poled structure such as the proton-exchanging method, the electron beam-scanning method, the electric voltage applying method, and others, which enables the generation and conversion of new laser wavelengths via material's nonlinearity under a specific QPM condition of temperature and pumping wavelength.

However, the tolerance for the QPM condition is very narrow, any insufficiency in inversion period results in failure to achieve the objective of producing small-sized, high-efficiency devices. Furthermore, the QPM-SHG wavelength conversion in general has a narrow temperature bandwidth and is sensitive to variations in temperature. Thus, it is common to use a temperature controlling apparatus to stabilize the device temperature for high-efficiency wavelength conversion (See: Michele Belmonte et al., J. Opt. A: Pure Appl. Opt. 1 (1999) 60-63.).

Even though there are several methods for preparing the periodically poled structure in which inverted lattices are nearly uniform in the direction of the thickness of the crystal, there is still a significant problem associated with the necessary of having the pumping radiation propagate in a tightly focused beam to provide adequate power density within the region of wave overlap. In bulk material, the pumping beam cannot be tightly focused since the propagation wave will diffract, resulting in low conversion efficiency. For these reasons, therefore, it is difficult to produce ideal QPM-SHG devices using this conventional method.

In addition, the use of lasers in a projection display enables the creation of vibrant images with extensive color coverage that is unachievable with conventional sources. One major obstacle is a phenomenon called speckle, which originates from the visible laser (See: Jahja I. Trisnadi, Proc. SPIE Vol. 4657, p. 131-137, Projection Displays VIII, Ming H. Wu; Ed.). Speckle arises when coherent light scattered from a rough surface, such as a screen, is detected by a square-law (intensity) detector that has a finite aperture such as an observer's eye. The image on the screen appears to be quantized into small areas with sizes equal to the detector resolution spot. The detected spot intensity varies randomly from darkest, if contributions of the scattering points inside the spot interfere destructively, to brightest if they interfere constructively. This spot-to-spot intensity fluctuation is referred as speckle. The characteristic granular size of the speckle is therefore the same as the size of the detector resolution spot.

### SUMMARY OF THE INVENTION

One aspect of the present invention provides a light-generating apparatus with a broadband pumping laser on a broadband QPM waveguide through at least a broadband sum frequency generation (SFG) to achieve temperature insensitive and speckle-free (speckle reduction) wavelength-converting device for high efficiency visible light.

A light-generating apparatus according to this aspect of the present invention comprises a broadband pumping laser configured to emit a broadband pumping light having a bandwidth substantially larger than 10 nanometers and a broadband wavelength-converting device with an acceptance bandwidth larger than 0.5 nanometers. The broadband wavelength-converting device includes a domain-inverted structure configured to convert the broadband pumping light into at least one conversion light by using at least a sum frequency generation mechanism and at least one waveguide positioned in the domain-inverted structure, and the waveguide has an input end configured to receive the broadband pumping light and an output end configured to output the conversion light.

Since the broadband pumping light has the bandwidth substantially larger than 10 nanometers and the acceptance bandwidth of the broadband wavelength-converting device is preferably larger than 0.5 nanometers, the conversion light is substantially a broadband incoherent light, which can prevent the speckle problem when it is used as light source of the display system. In addition, the broadband pumping laser provides the broadband pumping light and the acceptance bandwidth of the broadband wavelength-converting device is also wide enough such that there are always at least two corresponding bands in the acceptance bandwidth of the broadband wavelength-converting device for converting two portions of the broadband pumping light into the conversion light by using the sum frequency generation mechanism, even when the environmental temperature is not constant. Consequently, the light-generating apparatus does not need an expensive temperature-controlling system and thus it is temperature-insensitive.

Beside, using waveguides can further enhance nonlinear efficiency mixing as compared to bulk devices, by tightly confining the light over long distances. The tightly focused optical wave will often diffract when it propagates in a bulk device, so single-pass high conversion efficiency cannot be achieved. In waveguides, the mode profile is confined to a transverse dimension in the order of the wavelength, and hence high optical intensities can be maintained over considerable distance to improve the conversion efficiency by two to three orders of magnitude as compared to bulk devices. Also, the nonlinear mixing efficiency is quadratically proportional to the interaction length of the waveguide device (linear proportional for bulk devices), thus the fabrication of long, uniform and low-loss waveguide is essential for highly efficient wavelength-converting device.

Moreover, a tapered waveguide configuration within the crystal can be used to achieve high conversion efficiency without tightly focus the beam to increase the mode overlapping between the interaction lights (pumping light and conversion light) and the material nonlinearity (the polarization waves induced within the material).

### BRIEF DESCRIPTION OF THE DRAWINGS

The objectives and advantages of the present invention will become apparent upon reading the following description and upon reference to the accompanying drawings in which:

FIG. 1 and FIG. 3 illustrate a light-generating apparatus according to one embodiment of the present invention;

FIG. 4 and FIG. 5 illustrate broadband wavelength-converting devices according to other embodiments of the present invention;

FIG. 6 and FIG. 7 illustrate broadband wavelength-converting devices according to other embodiments of the present invention;

FIG. 8 illustrates a broadband wavelength-converting device according to another embodiment of the present invention;

FIG. 9 illustrates a broadband wavelength-converting device according to another embodiment of the present invention;

FIG. 10 illustrates a light-generating apparatus according to another embodiment of the present invention; and

FIG. 11 illustrates a light-generating apparatus according to another embodiment of the present invention.

### DETAILED DESCRIPTION OF THE INVENTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

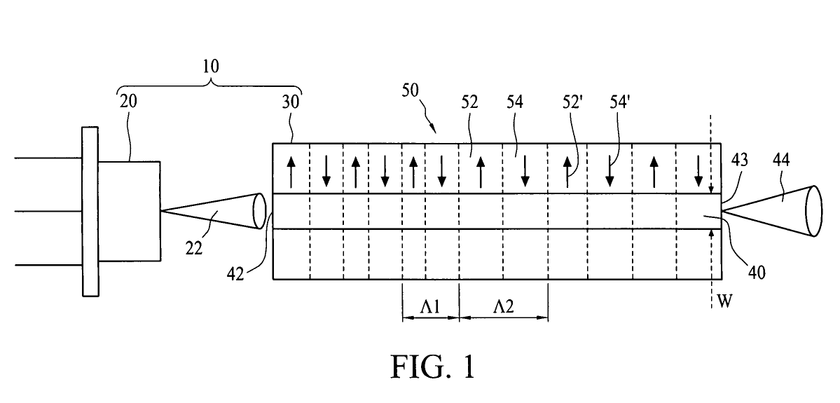

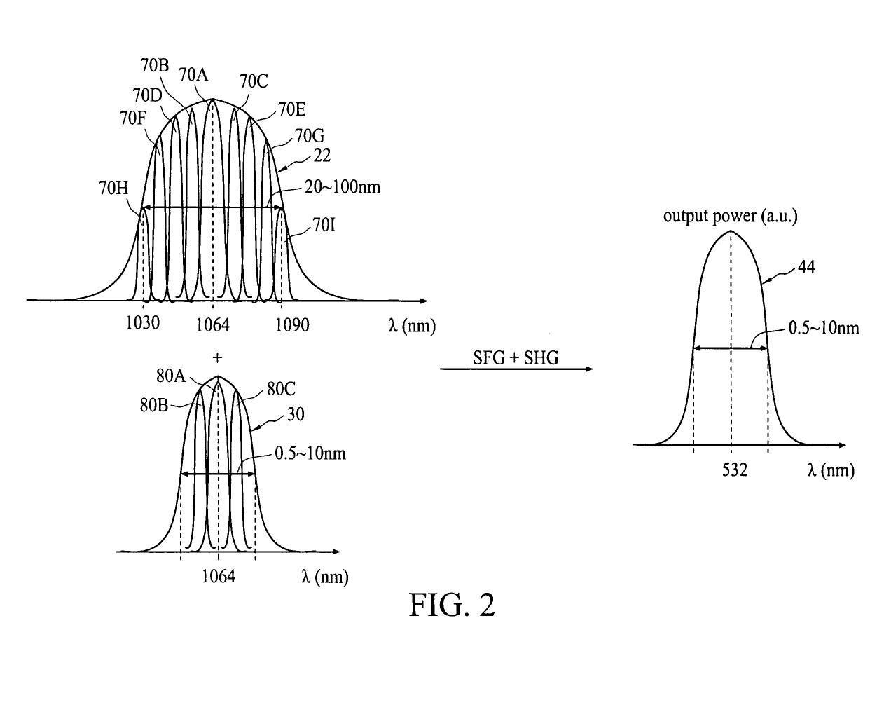

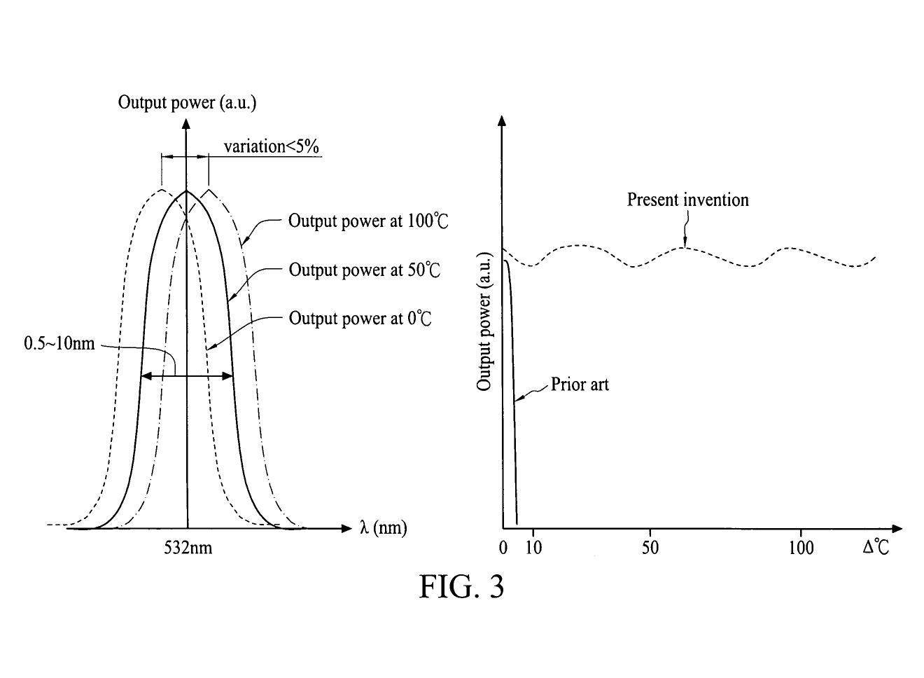

FIG. 1 and FIG. 3 illustrate a light-generating apparatus 10 according to one embodiment of the present invention. The light-generating apparatus 10 comprises a broadband pumping laser 20 configured to emit a broadband pumping light 22 and a broadband wavelength-converting device 30 including a domain-inverted structure 50 configured to convert the broadband pumping light 22 into a conversion light 44 by using at least a sum frequency generation (SFG) mechanism and at least one waveguide 40 positioned in the domain-inverted structure 50. The waveguide 40 includes an input end 42 configured to receive the broadband pumping light 22 and an output end 43 configured to output the conversion light 44.

The domain-inverted structure 50 includes a plurality of first domains 52 having a first polarity 52′ and a plurality of second domains 54 interlaced in the first domains 52, with the second domains 54 having a second polarity 54′ opposite to the first polarity 52′. The domain-inverted structure 50 may have a non-uniform period (Λ); for example, the period varies along a propagation direction of the broadband pumping light 22. The domain-inverted structure 50 includes a first portion having a first period (Λ1) and a second portion having a second period (Λ2) different from the first period (Λ1). In addition, the output end 43 of the broadband wavelength-converting device 30 may be optionally cascaded with another broadband wavelength-converting device configured to convert the conversion light 44 (for example, 532 nm) and the pumping light 22 (for example, 1064 nm) into a ultra-violet (UV) light.

Referring to FIG. 2, the broadband pumping laser 20 can be a pulsed laser, which can emit the broadband pumping light 22 with high power such as a pulsed pumping light. Preferably, the broadband pumping light 22 has a bandwidth larger than 10 nanometers; for example, the bandwidth of the broadband pumping light 22 is between 20 and 100 nanometers. The acceptance bandwidth of the broadband wavelength-converting device 30 is preferably larger than 0.5 nanometers; for example, between 0.5 and 10 nanometers. The acceptance bandwidth of the broadband wavelength-converting device 30 can be between 1 and 10 nanometers; preferably, between 2 and 5 nanometers. Consequently, the bandwidth of the conversion light 44 is larger than 2 nanometers, i.e., a broadband incoherent light, which can prevent the speckle problem when it is used as light source of the display system. In particular, the bandwidth of the broadband pumping light 22 is larger than the bandwidth of the conversion light 44.

The acceptance bandwidth of the broadband wavelength-converting device 30 is wide enough to include at least two narrow bands 80B and 80C; in addition, the broadband pumping laser 20 provides the broadband pumping light 22 also including several narrow bands 70A-70I. Consequently, the two narrow bands 80B and 80C of the broadband wavelength-converting device 30 can be used to convert the two narrow bands 70B and 70C of the broadband pumping light 22 into the conversion light 44 by the using the sum frequency generation (SFG) mechanism. Moreover, the narrow band 80A of the broadband wavelength-converting device 30 can be used to convert the narrow band 70A of the broadband pumping light 22 into the conversion light 44 by the using the second harmonic generation (SHG) mechanism.

Referring to FIG. 3, the variation of the environmental temperature easily causes a lateral shift of the acceptance bandwidth of the broadband wavelength-converting device 30. Since the light-generating apparatus 10 uses the broadband pumping light 22 including several narrow bands 70A-70I, there are always at least two corresponding narrow bands; for example the narrow bands 70B and 70F as the acceptance bandwidth of the wavelength-converting device 30 has a left shift, overlapping with the two narrow bands 80B and 80C of the broadband wavelength-converting device 30 for the sum frequency generation (SFG) mechanism. In addition, there is also at least one narrow band; for example the narrow band 70D as the acceptance bandwidth of the wavelength-converting device 30 has a left shift, overlapping with the narrow band 80A of the broadband wavelength-converting device 30 for the second harmonic generation (SHG) mechanism.

In other words, the relative shift of the acceptance bandwidth of the broadband wavelength-converting device 30 is smaller than the bandwidth of the broadband pumping laser 20, even when the environmental temperature is not constant. Consequently, the light-generating apparatus 10 does not need an expensive temperature-controlling system and thus it is temperature-insensitive. Consequently, the output power of the conversion light 44 maintains at a high level even the environmental temperature varies from 0 to 100° C. In contrast, the prior art spends effort on combining the narrow band laser and the narrow band wavelength-converting device; however, the output power drops dramatically even the variation of the environmental temperature is within 10° C., that is way the prior art needs to use a high performance temperature controlling apparatus to stabilize the device temperature for high-efficiency wavelength conversion.

In addition to the sum frequency generation mechanism, there is always a corresponding band in the acceptance bandwidth of the broadband wavelength-converting device 30 for converting a portion of the broadband pumping light 22 into the conversion light 44 using a second harmonic generation mechanism. Furthermore, it is much easier to prepare the broadband wavelength-converting device 30 with domains having non-uniform width, as compared to the preparation of the wavelength-converting device with domains having uniform width.

In particular, the high conversion efficiency of the waveguide 40 mostly couples with an issue of high loss of pumping when guiding the power of the broadband pumping light 22 into the waveguide 40. According to the embodiments of the present invention, through the broadband pulsed high power pumping laser 20, a low loss waveguide 40 is effective to couple much more power to enable a higher specific output even with a lower conversion efficiency. In addition, using broadband pulsed high power pumping laser 20 allows the light-generating apparatus 10 to effectively couple more power into the waveguide 40 and this enables higher specific output even with lower conversion efficiency.

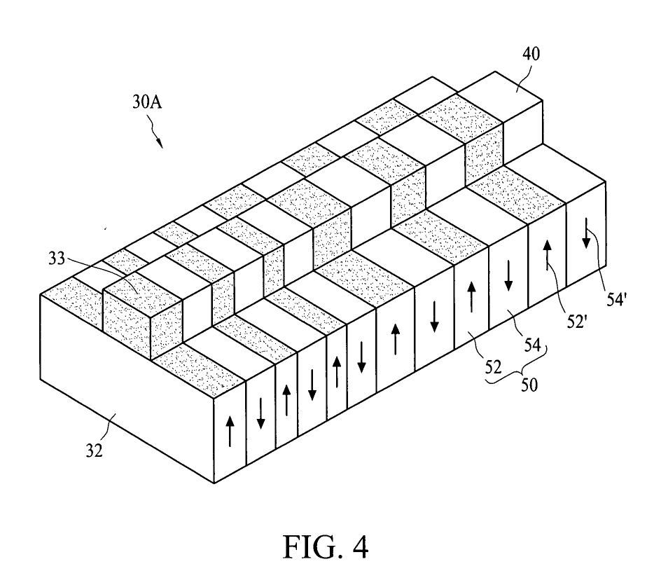

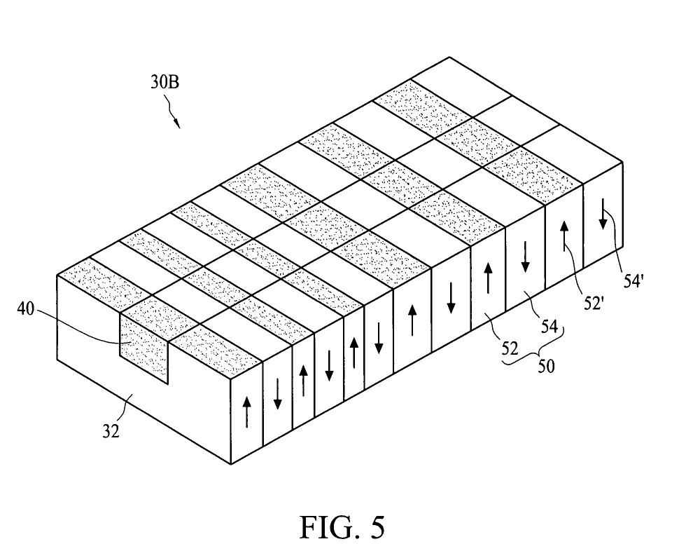

FIG. 4 and FIG. 5 illustrate broadband wavelength-converting devices 30A, 30B according to other embodiments of the present invention. Referring to FIG. 4, the broadband wavelength-converting device 30A includes a substrate 32 and a ridge 33 on the substrate 32, and the waveguide 40 is positioned in the ridge 33, i.e., the broadband wavelength-converting device 30A uses a ridge waveguide design. In contrast, the waveguide 40 of the broadband wavelength-converting device 30B is embedded in the substrate 32, as shown in FIG. 5.

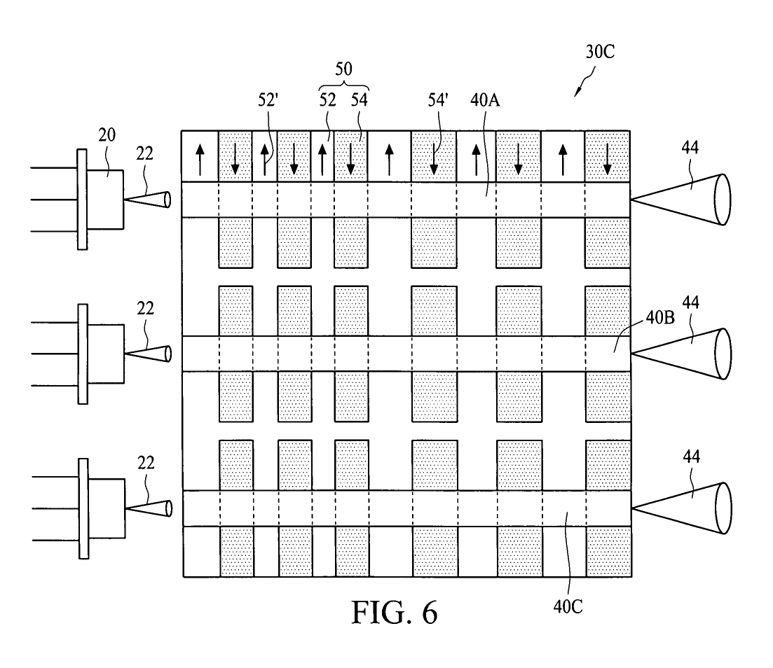

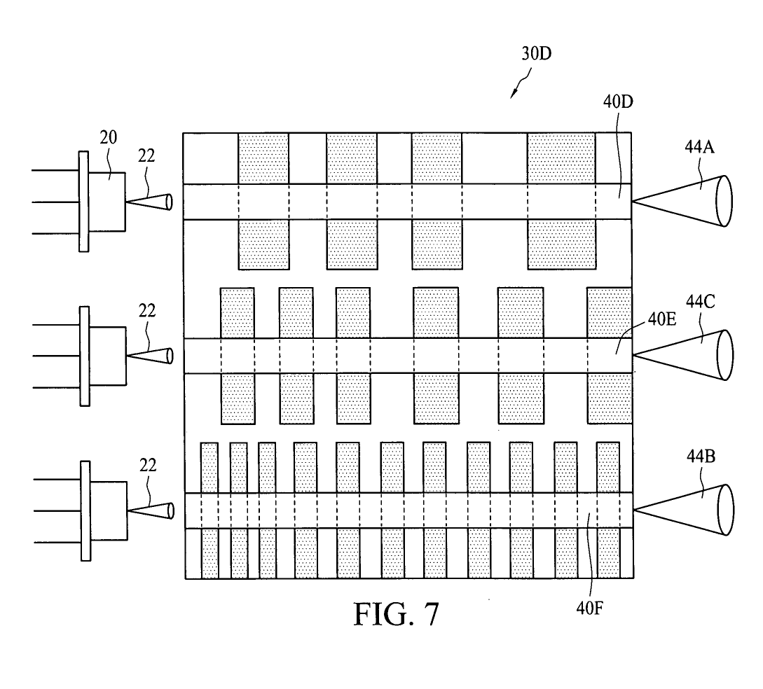

FIG. 6 and FIG. 7 illustrate broadband wavelength-converting devices 30C, 30D according to other embodiments of the present invention. Referring to FIG. 6, the broadband wavelength-converting device 30C includes three waveguides 40A, 40B, 40C configured to convert the broadband pumping light 22 into the conversion lights 44. In contrast, the broadband wavelength-converting device 30D includes more than three waveguides 40D, 40E, 40F configured to convert the broadband pumping light 22 into a red light 44A, a blue light 44B, and a green light 44C.

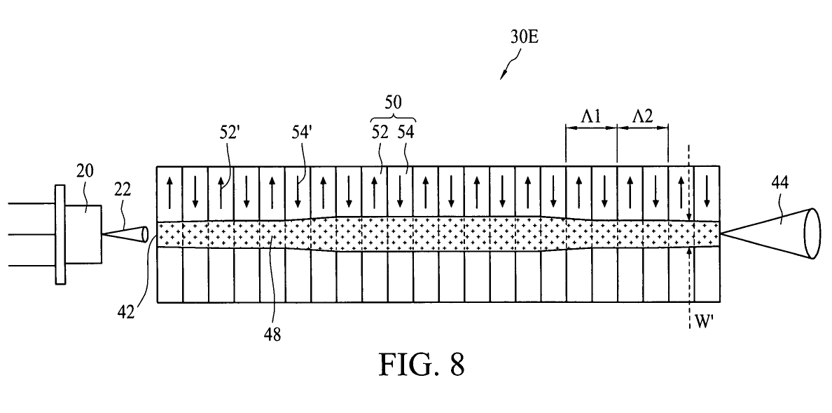

FIG. 8 illustrates a broadband wavelength-converting device 30E according to another embodiment of the present invention. Compared with the broadband wavelength-converting device 30 having a waveguide 40 having a uniform width (W) along the propagation direction of the broadband pumping light 22 in FIG. 4, the broadband wavelength-converting device 30E includes a tapered waveguide 48 having a non-uniform width (W′) along the propagation direction of the broadband pumping light 22. The mode size transformation allows independent optimization of the mode size in different portions of the tapered waveguide 48. This increases the input and output coupling efficiency as well as the efficiency of active or electro-optic devices. In particular, the domain-inverted structure 50 of the broadband wavelength-converting device 30E has a uniform period (Λ) along the propagation direction of the broadband pumping light 22, i.e., the period (Λ1) is substantially the same as the period (Λ2).

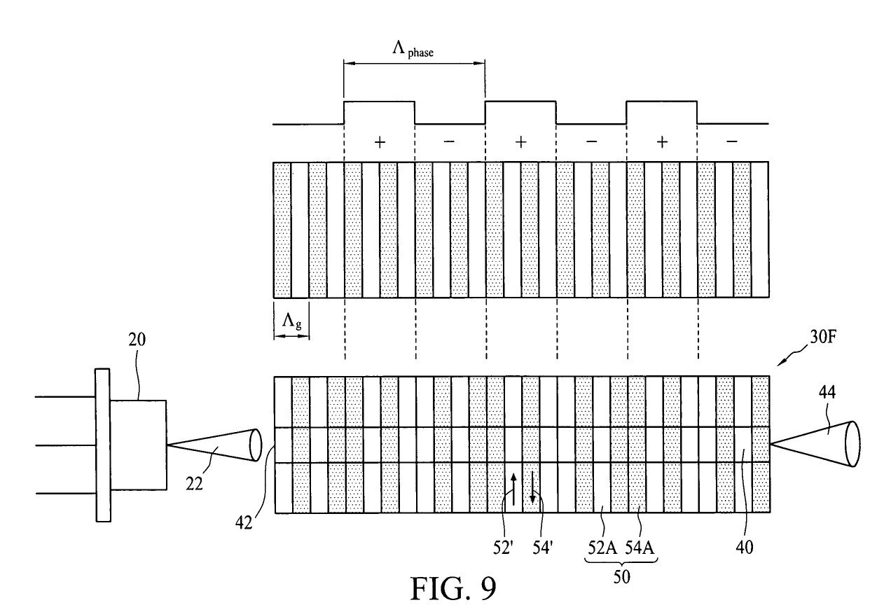

FIG. 9 illustrates a broadband wavelength-converting device 30F according to another embodiment of the present invention. The domain-inverted structure 50′ includes a plurality of first domains 52A having a first polarity 52′ and a plurality of second domains 54A interlaced in the first domains 52A, with the second domains 54A having a second polarity 54′ opposite to the first polarity 52′. The broadband wavelength-converting device 30F can be obtained by superimposing a phase-reversal grating of period (Λₚₕₐₛₑ) with a substantially 50% duty cycle on a uniform QPM grating of period (Λ_{g}) with a substantially 50% duty cycle. In particular, the domain-inverted structure 50′ of the broadband wavelength-converting device 30G has a uniform period (Λ_{g}) along the propagation direction of the broadband pumping light 22.

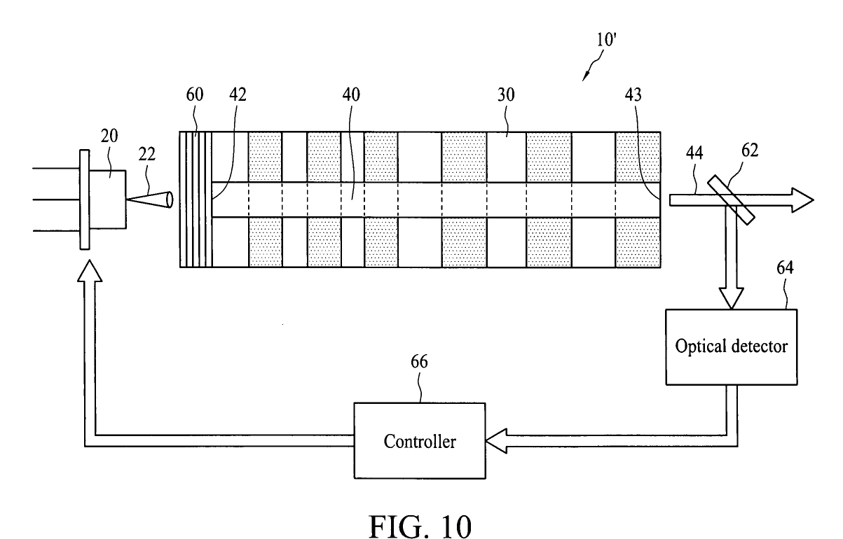

FIG. 10 illustrates a light-generating apparatus 10′ according to another embodiment of the present invention. Compared with the light-generating apparatus 10 in FIG. 1, the light-generating apparatus 10′ further comprises an optical detector 64 configured to detect the intensity of the conversion light 44, a controller 66 configured to control an input current to the broadband pumping laser 20 by taking the intensity of the conversion light 44 into consideration, and a splitter 62 configured to split a portion of the conversion light 44 to the optical detector 64. In addition, the broadband wavelength-converting device 30 further comprises a band-pass filter 60 positioned on the input end 42 of the waveguide 40, and the band-pass filter 60 can be a multi-layer structure coated on the input end 42 of the waveguide 40.

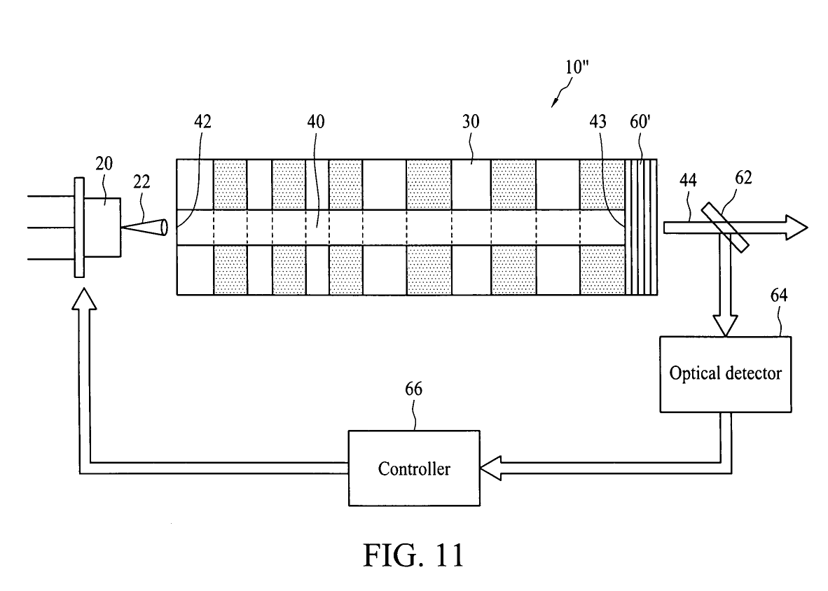

FIG. 11 illustrates a light-generating apparatus 10″ according to another embodiment of the present invention. Compared with the light-generating apparatus 10′ having the band-pass filter 60 coated on the input end 42 of the waveguide 40 in FIG. 10, the light-generating apparatus 10″ has a band-pass filter 60′ coated on the output end 43 of the waveguide 40, and the band-pass filter 60′ can be a multi-layer structure coated on the output end 42′ of the waveguide 40.

It will be appreciated by those skilled in the art having the benefit of this disclosure that this invention provides an adjustable and versatile gun rest apparatus having numerous uses and applications. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A light-generating apparatus, comprising:
a broadband pumping laser configured to emit a broadband pumping light having a bandwidth larger than 10 nanometers; and
a broadband wavelength-converting device including a domain-inverted structure configured to convert the broadband pumping light into at least one conversion light by using at least a sum frequency generation mechanism and at least one waveguide positioned in the domain-inverted structure, the waveguide having an input end configured to receive the broadband pumping light and an output end configured to output the conversion light.

2. The light-generating apparatus of claim 1, wherein the broadband pumping laser is a pulsed laser.

3. The light-generating apparatus of claim 1, wherein the bandwidth of the broadband pumping light is larger than the bandwidth of the conversion light.

4. The light-generating apparatus of claim 1, wherein the domain-inverted structure is further configured to convert the broadband pumping light into the conversion light by using a second harmonic generation mechanism.

5. The light-generating apparatus of claim 1, wherein the broadband wavelength-converting device includes a plurality of waveguides configured to convert the broadband pumping light into the conversion light.

6. The light-generating apparatus of claim 1, wherein the broadband wavelength-converting device includes three waveguides configured to convert the broadband pumping light into a red light, a blue light, and a green light.

7. The light-generating apparatus of claim 1, wherein the broadband wavelength-converting device includes a substrate and a ridge on the substrate, and the waveguide is positioned in the ridge.

8. The light-generating apparatus of claim 1, wherein the broadband wavelength-converting device includes a substrate, and the waveguide is embedded in the substrate.

9. The light-generating apparatus of claim 1, wherein the domain-inverted structure includes a plurality of domains having alternating polarity.

10. The light-generating apparatus of claim 1, wherein the period of the domain-inverted structure varies along a propagation direction of the broadband pumping light.

11. The light-generating apparatus of claim 10, wherein the domain-inverted structure includes a first portion having a first period and a second portion having a second period different from the first period.

12. The light-generating apparatus of claim 1, wherein the period of the domain-inverted structure is substantially the same along a propagation direction of the broadband pumping light.

13. The light-generating apparatus of claim 12, wherein the waveguide is a tapered waveguide having a non-uniform width along a propagation direction of the broadband pumping light.

14. The light-generating apparatus of claim 12, wherein there a plurality of first domains and second domains in one period of the domain-inverted structure, and the polarity of the first domains is different from the polarity of the second domains.

15. The light-generating apparatus of claim 1, further comprising:
an optical detector configured to detect the intensity of the conversion light;
a controller configured to control an input current to the broadband pumping laser by taking the intensity of the conversion light into consideration.

16. The light-generating apparatus of claim 15, further comprising a splitter configured to split a portion of the conversion light to the optical detector.

17. The light-generating apparatus of claim 1, wherein the broadband wavelength-converting device further comprises a band-pass filter positioned on the input end of the waveguide.

18. The light-generating apparatus of claim 1, wherein the broadband wavelength-converting device further comprises a band-pass filter positioned on an output end of the waveguide.

19. The light-generating apparatus of claim 1, wherein the bandwidth of the broadband pumping light is between 10 and 100 nanometers.

20. The light-generating apparatus of claim 1, wherein the bandwidth of the broadband pumping light is between 20 and 100 nanometers.

21. The light-generating apparatus of claim 1, wherein the broadband wavelength-converting device has an acceptance larger than 0.5 nanometers.

22. The light-generating apparatus of claim 1, wherein the broadband wavelength-converting device has an acceptance bandwidth between 0.5 and 10 nanometers.

23. The light-generating apparatus of claim 1, wherein the broadband wavelength-converting device has an acceptance bandwidth between 2 and 10 nanometers.
